(19) United States
(12) Patent Application Publication
(10) Pub. No.: US 2011/0089183 A1
(43) Pub. Date: Apr. 21, 2011

(54) COMPOSITE PANEL AND ITS PRODUCTION

(76) Inventor: Herbert Gundelsheimer, Bamberg (DE)

(21) Appl. No.: 12/681,377

(22) PCT Filed: Oct. 2, 2007
(86) PCT No.: PCT/NL07/00250

§ 371 Date: Dec. 10, 2010

(51) Int. Cl. B65D 5/42; B32B 3/12; B32B 38/08; B32B 38/00

(52) U.S. Cl. 220/626; 428/117; 156/197; 156/73.1

(57) ABSTRACT

The invention relates to a method for producing a composite panel comprising a paper honeycomb core (3) and a panel (2,2′) attached to both sides of the honeycomb core (3) in a continuous process, said method comprising the steps of producing a continuous paper honeycomb from at least one band of paper by cutting strips (12) of paper in substantially transverse direction off of the band of paper, stacking said strips (12) onto one another while being attached at various locations along the length of the strips to form the continuous honeycomb in compressed form, expanding said compressed continuous paper honeycomb and impregnating it with a curable composition (7), impregnating a first and second continuous fibre-reinforced web with said curable composition (7), or a further curable composition which chemically binds to said curable composition (7), removing entrapped air from said impregnated fibre-reinforced web, applying said first and second impregnated fibre-reinforced web against respective both sides of said impregnated paper honeycomb core (3) to form a continuous composite panel, feeding said continuous composite panel through a curing station for continuously curing said curable composition (7); cutting a composite panel from said continuous composite panel. The invention further relates to a composite panel comprising a paper honeycomb core (3), and cladding sheets (2,2′) attached to both sides of the honeycomb core (3), said cladding sheets (2,2′) comprising a fibre reinforced with a curable composition and are attached to said honeycomb core (3) via said curable composition (7), wherein said paper honeycomb core (3) has been impregnated with said curable composition (7). before it was provided with the cladding sheets (2,2′), has cells with an inscribed circle diameter of 4-25 mm, and is composed of paper strips (12) which are lengthwise oriented in the transverse direction of the panel

### BACKGROUND

The present invention relates to a method for producing a composite panel, and a composite panel comprising a paper honeycomb core, and cladding sheets attached to both sides of the honeycomb core.

GB-912.443 of 1960 already discloses a composite sheet in which a resin-impregnated glass fibre sheet is impregnated with a polyester, epoxide, urea, phenolic or hard setting grade of polythene, and said impregnated sheets are applied to a paper honeycomb core. To that end, first one sheet is applied to the paper honeycomb core, said paper is allowed to absorb resin and the resin is cured. Subsequently, a second impregnated sheet is applied to the other side of the paper honeycomb core and is allowed to set. Thus, the composite sheet is not fully integrated.

GB-932.842 discloses a composite sheet which uses a grating, which may be a honeycomb or grid-like structure, of glass fibre reinforced plastics material and applying pre-hardened glass-fibre reinforced plates on the grating and allowing the sheet to harden fully.

WO-2006/079860 discloses a panel which has a honeycomb core which is glued upon reinforcement plates using a glue which chemically reacts with the matrix resin of the reinforcement plates.

GB-1.145.782 discloses a process in which in a mould a first shell was produced of mixture of glass fibres and polyester resin and a honeycomb core of coiled paper impregnated with phenolic resin was pressed against the shell and cured. Subsequently, a top shell was formed and cured. The top shell was then placed on the first shell with honeycomb core, the rims of the shells were filled additional glass fibre and resin and again cured. Thus, the core and shells are not fully integrated.

In WO-2002/057073 a paper honeycomb core is impregnated with an inorganic filler in order to enhance strength and flame retardancy, and using an additional adhesive layer applied onto face sheets to adhere them to the core.

US-5.037498 discloses a process for continuously molding honeycomb panel. In this process, a honeycomb core of aromatic polyamide fibre impregnated with phenolic resin is laminated on both sides with a prepreg and pressed with hot plates for a preset time for curing. The press plates prevent a continuous production.

US-4.049.487 discloses a method for producing honeycomb panelling by applying continuous webs of resin-impregnated fibrous web to the two faces of a honeycomb core. Again, adherence of the layers remains a problem.

### SUMMARY OF THE INVENTION

The invention aims to provide a composite panel and a method for producing a composite panel which is cheap, and provide a composite panel which is rigid and strong, and resistant against delamination.

According to a first aspect of the invention this is realized with a method for producing a composite panel comprising a paper honeycomb core and a panel attached to both sides of the honeycomb core in a continuous process, said method comprising the following step of producing a continuous paper honeycomb from at least one band of paper by cutting strips of paper in substantially transverse direction off of the band of paper, stacking said strips onto one another while being attached at various locations along the length of the strips to form the continuous honeycomb in compressed form. Expanding said compressed continuous paper honeycomb and impregnating it with a curable composition.

An additional step is impregnating a first and second continuous fibre-reinforced web with said curable composition, or a further curable composition which chemically binds to said curable composition.

A further step is removing entrapped air from said impregnated fibre-reinforced web.

A next step can be applying said first and second impregnated fibre-reinforced web against respective both sides of said impregnated paper honeycomb core to form a continuous composite panel.

An additional step is feeding said continuous composite panel through a curing station for continuously curing said curable composition.

An additional step can be cutting a composite panel from said continuous composite panel.

The invention further relates to a composite panel comprising a paper honeycomb core, and cladding sheets attached to both sides of the honeycomb core, said cladding sheets comprising a fibre reinforced with a curable composition and are attached to said honeycomb core via said curable composition, wherein said paper honeycomb core has been impregnated with a further or said curable composition before it was provided with the cladding sheets, has cells with an inscribed circle diameter of 4-25 mm, and is an composed of continuous paper strips which are lengthwise oriented in the transverse direction of the panel.

Although the cited references show that much work has been done in the last 50 years, there still is no composite panels, or method for producing a composite panel, which allows panels to be produced which are very cheap, large enough to be used for instance as flooring member without the need for combining several arts for obtaining one single flooring member, and which is strong enough, both in transverse direction as well as with respect to its resistance against delamination, and which is inert against detrimental environmental effects such as water and moisture, rodents, pests, etc.

In an embodiment, the fibre web used for the honeycomb material is a web which largely consists of cellulose fibres. The fibres may comprise a small amount of other fibres which are know as reinforcement fibres in paper of paper-like webs. The paper can be reinforced by using chemical additives to enhance the connection between the fibres. Also the rigidity of the fibres can be enhanced by using specific chemical additives as isocyanaat or isocyanate-functional compounds.

In an embodiment, the fibre web used for the honeycomb material is a paper web. Usually, CCM (=Corrugated Core Material), Liner, Kraft or Semi Chemical paper will be used.

The use of a continuous honeycomb core allows the production of large panels, with a width of about 1.2-2.5 meter of even more. The upper limit of the width is only limited by the width of rolls of paper. These panels, because of the use of continuous honeycomb core, have a uniform strength without more rigid stripes or part, which result from the use of for instance various blocks of honeycomb material in one panel, or honeycomb core material produced in an other, discontinuous way. The panels of the invention may have an endless length, i.e., in practice one is free to chose the desired length. In that way, these panels can for instance be used as one-part flooring, for use in containers for instance.

In an embodiment, the fibre-reinforced web is a non-woven web.

The fibre-reinforced web in an embodiment largely comprises glass fibres. In an embodiment, the web is a non-woven glass fibre web. In particular, in an embodiment, the webs used in the cladding sheet comprise a glass fiber material which has specific properties in various directions, in particular regarding stress and strain. This determines to a high degree the resistance against deformation. For instance, polyester gives a high load carrying capacity, but has brittle construction which can be loaded dynamically. A large part of this dynamic load can be carried by the glass fiber material. The glass fiber web can be a roving or non-roving material. In particular, in an embodiment the fiber-reinforced web is a so-called multi axial fabric of multi axial web with fibers oriented in 2 or 3 directions. It can also be a 2-layer weaved fabric or a weaved fabric with various directions (ATLAS-fabric).

In an embodiment the curable composition is a curable resin composition and comprises at least one curable resin. In this description, a curable resin is a resin which has a polymer backbone with functional groups allowing the resin to crosslink in order to form a thermohard synthetic material. In an embodiment, the curable resin is selected from the group consisting of polyester, polyurethane, phenol-formaldehyde resins PF, urea-formaldehyde resins UF, melamine resins MF, melamine-phenol-formaldehyde resins MP, unsaturated polyester resins UP, epoxy resins EP, diallylphthalate resins DAP, silicone resins, polyurethane resins PUR, and combinations thereof.

In another embodiment, the curable composition is a composition of crosslinkable monomers or pre-polymers, curable under the influence of heat (IR radiation), UV radiation. Examples of these components comprise caprolactam, (meth)acrylate, monomomers which polymerize via ring opening polymerization, e.g. caprolactame, laurinlactame, lactone etc., monomers or prepolymers, which polymerize or cure under irradiation of UV light: acrylates, e.g. Epoxyacrylate, Urethanacrylate, polyesteracrylate, Polyetheracrylate, Acrylacrylate, Melaminacrylate, Siliconeacrylate (Organically modified ceramics, ORMOCERE), monomers or prepolymers which polymerize or cure under the influence of UV Light or heat polymerisation, eventually in the presence of radical starters, e.g. azobisisobutyronitrile (ABIN): acrylates, vinylether, vinylester etc., monomers or prepolymers which polymerize or cure or crosslinking under the influence of or induced by irradiation with electron beams.

In an embodiment, the curable composition may cure of crosslink or polymerize under influence of heat production inside the honeycomb structure by irradiation with microwaves in the presence of monomers, prepolymers or any kind of reactive resin, which due to its chemical structure is capable of microwave energy absorption, e.g. all chemical structures, which contain polar functional groups, preferably hydroxyl groups and combinations thereof (e.g., hybrid resins) and combinations with the above given duroplastic resins (PUR, UP etc.).

In an embodiment, the curable composition comprises a thixotrophy modifying component. In particular the thixotrophy modifying component is a component which increases the viscosity when no force such as a sheer force is applied to the resin. These components, as such, are known to the skilled person. A suitable thixotrophy additive is for instance a product marketed under the name of Aerosil®, which is a “pyrogenic silicic acid”, also called a nano size silicium carbid. Other thixotophy modifying agent which may be used are bentonite, kaoline, and alginic acid. These components are mixed into the curable composition before it is applied.

In an embodiment, the curable composition of the fibre-reinforced web comprises a thixotrophy-modifying agent. In a further embodiment, only the curable composition of the fibre-reinforced web comprises the thixotrophy-modifying agent.

In an embodiment, the paper band is partly thorn in order to provide fibre ends protruding from the edge of the honeycomb material. In an embodiment, additional roughening of the edges can be applied in order to increase the amount of fibre ends after the honeycomb material is produced, but preferably before it is expanded and, in an embodiment, before the resin composition is applied to the honeycomb material.

In an embodiment, the honeycomb core material is produced by attaching strips of paper to one another. In an embodiment, the honeycomb core material is produced using at least two band of paper-like material. In a further embodiment a multiplicity of each time two bands of paper are used. In this embodiment, there is are first bands of paper and second bands of paper.

The method is described for two bands of paper-like web, but it will be evident that multitudes of two bands can be used. The amount of bands is usually limited by the amount of sheets that can be properly cut. In order to form the honeycomb core material, adhesive composition is applied along longitudinal lines, regularly spaced at a line distance which determines the size of the cells, on the first band of paper-like material. Next, the second band of paper-like material is applied on the first band of paper-like material, adhesive composition is applied on the second band of paper again along longitudinal lines, regularly spaced at about the same line distance as the adhesive on the first band, but between the lines of adhesive on the first band. Usually, the offset will be about half the spacing of the lines on the first band. In that way, the cells will be almost hexagonally shaped.

Next, a strip is cut off the end of the bands which are attached to one another using the adhesive composition. The width of the strip determines the height of the honeycomb material. A next stack of strips is applied on the previous one, thus creating an endless honeycomb core material. The width of the stack of strips thus determines the height of the honeycomb core material in its un-expander form.

The length of the strips is in fact the width of the final honeycomb. Produced in such a way an endless flow of honeycomb is created that is still compact. The use in the panels requires the expanding of the honeycomb, hence by this, opening the cell structure and establishing the opened web of cells. This results in a reduction of the width of the honeycomb to a ratio of 0.75 to 0.79.

For creating isoform properties, it is of importance to have continuous honeycomb web over the full width of the panel. The width of the panel may require specifically large honeycomb width like 2600 mm, 2800 mm and more.

In this respect a symmetric cell form on every place in the web of honeycomb is required. For the technical properties in relation to the required strength and bending characteristics small cell sizes as cells with for example 10 mm, 8 mm or even smaller inner circle.

In an embodiment of the invention, said step of producing the continuous paper honeycomb comprises the steps of providing sets of two rolls of paper material, and unrolling set of two rolls into a first and second band of paper material. A further step may be applying adhesive material along lines on one side of said first bands of paper material of said sets. A next step can be applying adhesive material along lines on one side of said second bands of paper material of said sets, said lines halve a pitch offset with respect to said lines on said first bands of paper material. Using a combination of these steps allows the production of an in principle endless honeycomb material and with a large width, up to 2.5 meters and more.

In an embodiment, said curable composition is a curable resin composition.

In a further embodiment, said curable composition is a curable resin composition which substantially comprises a resin selected from the group consisting of polyester, polyurethane, epoxy, and combinations thereof.

In another embodiment, said honeycomb core material is impregnated with a curable composition comprising compounds selected from the group consisting of caprolactam, acrylate monomers, isocyanate functional molecules.

In another embodiment, said step of removing entrapped air comprises the step of subjecting said impregnated fibre reinforced web to ultrasound of micro vibrations before application against respective both sides of said impregnated paper honeycomb core.

In another embodiment, the method further comprises the step of processing sides of said strips of paper of said honeycomb for providing free fibre ends extending from said sides.

In another embodiment, the method further comprises the step of processing sides of said strips of paper of said honeycomb for increasing the adhesive surface of said honeycomb with said panels.

In yet another embodiment, the method further comprises the step of adding a thixotrophy modifying agent to said curable resin composition before impregnating said first and second continuous fibre-reinforced web with it.

In an embodiment, said continuous paper honeycomb is impregnated before being expanded.

In another embodiment, a pattern of said curable composition is produced on said web on the side where the honeycomb core material is applied, which pattern matches the side of the honeycomb core material.

In a further embodiment of the composite panel said cells have an inscribed circle diameter of 5-10 mm.

In yet a further embodiment, said honeycomb core has a height of 4-20 mm.

In another embodiment, the composite panel has a width of about 1.2-2.5 m and the honeycomb core is a continuous honeycomb core.

In another embodiment, said paper strips have a length of at least 2000 mm.

In another embodiment, said honeycomb core comprises at least two stacked honeycomb layers, with a cladding sheet between each honeycomb layer.

In an embodiment, the invention relates to a floor panel, in particular for a shipment container, comprising the composite panel described above.

In an embodiment, this floor panel comprises one composite panel described above extending over its width and length.

The invention further relates to an apparatus comprising one or more of the characterising features described in the description and/or shown in the attached drawings.

The invention further relates to a method comprising one or more of the characterising features described in the description and/or shown in the attached drawings.

The various aspects discussed in this patent can be combined in order to provide additional advantages.

### DESCRIPTION OF THE DRAWINGS

The invention will be further elucidated referring to an embodiment of a method for producing a composite panel, and a composite panel, and shown in the attached drawings, showing in:

FIG. 1 a top view of a part of a composite panel of the invention;

FIG. 2 a top view of a detail of a part of a honeycomb core;

FIG. 3 a transverse cross section of a part of the composite panel of FIG. 1;

FIG. 4 schematically the production step of a continuous honeycomb core;

FIG. 5 the step of expanding the honeycomb core material;

FIG. 6 a multi-layer composite panel;

FIG. 7 the step of impregnation of a honeycomb core;

FIG. 8 schematically several steps of applying the continuous fibre-reinforced webs to the composite panel;

FIG. 9 schematic drawing of a possible distribution of curable material on the cladding sheet, and

FIG. 10 A drawing showing the impregnation step of the honeycomb material.

### DETAILED DESCRIPTION OF EMBODIMENTS

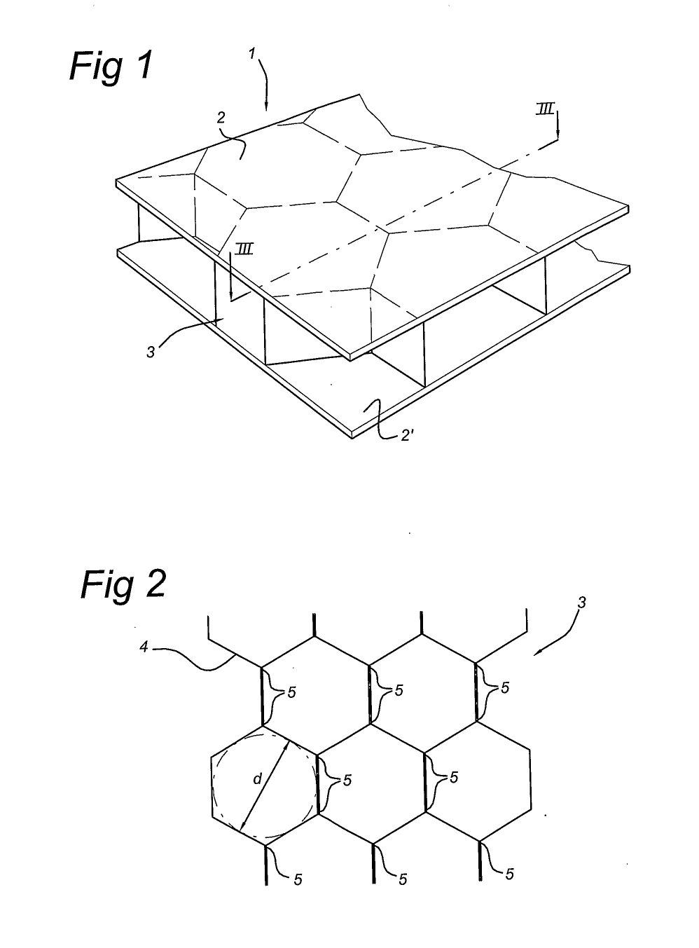

In FIG. 1, a top view of an example of a composite panel according to the present invention is shown. This composite panel 1 has cladding sheets 2, 2′ and a honeycomb core 3.

In FIG. 2, a top view of an example of a honeycomb core 3 is shown. It is produced from strips of material 4, attached to one another at the regions 5, where double layers of material exist. A well-known manner of attaching the strips of material to one another is using glue. To that end, glue can be applied at the entire contact region 5.

Another method is applying dots or stripes of glue, for instance near the angled areas. The regions 5 may be very narrow. In that case, the cells or the honeycomb material can be almost rectangular or diamond-shaped. In fact, depending on the quality of the material used for the honeycomb, the cells can be almost round. For attaching the material, hot-melt glue can be used which is well-known in the art. It may also be possible to use any other type of adhesive known in the production of honeycomb material.

In FIG. 2, it is further indicated that the honeycomb material can be specified using the size of the cells. Usually, the diameter of the inscribing circle d is used as a measure to define the honeycomb material. When honeycomb material is used which is not fully expanded, leading to cells which are have a elliptic shape, the inscribed circle is the circle which would result if the material were fully expanded.

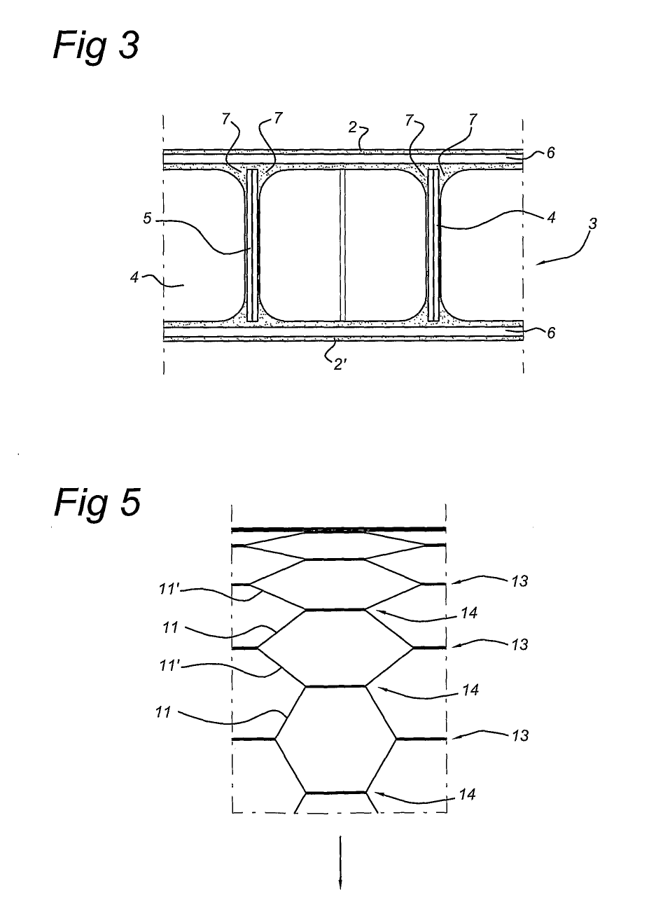

In FIG. 3, a cross-section of the composite panel of FIG. 1 along lines is shown. The cladding sheets or panels 2, 2′ are composed of fibrous material 6 embedded in a polymeric matrix material 7 which results from the curing of a curable composition. The strips of material 4 of the honeycomb core material are also embedded in polymeric material 7. In an embodiment, a thixotrophy-modifying agent is added to the curable composition before it is used for embedding the fibrous material of the cladding sheets 2, 2′ and the honeycomb core 3. In this way, meniscuses of cured material are formed at the locations of areas where the honeycomb material and the cladding sheets 2 meet, as indicated in the drawing. In an embodiment, the honeycomb core material is impregnated with an isocyanete or isocyanate-functional material. This will cure in the presence of moisture and build a foamed material and can provide an increased resistance against pressure forces on the composite panel.

In FIG. 5, a production process for the honeycomb core is shown. In this example, two rolls of material 10, 10′ are used, but for increased production speed, a plurality of sets of two rolls may be used. Resulting in a thicker stack 12 which is added each time.

In this process, two rolls 10, 10′ of material are provided. These rolls are unrolled parallel to one another, resulting in bands 11, 11′. These bands 11, 11′ are placed on top of one another. First, however, the lower band 11 is provided with adhesive material. The adhesive material is provided in an area 14 indicated with two lines. These areas are equally spread at a regular distance or spacing, at a predetermined pitch which determines part of the diameter of the inscribed circle of the cells of the honeycomb. As already shown in FIG. 2, the width of the area more or less determines the length of one part of the honeycomb (indicated with number 5 in FIG. 2). The spacing of the areas 14 more or less determines the length of the other parts of the honeycomb.

The adhesive material within areas 14 may be applied as continuous lines or as dots. This, however, as known to the skilled person. The nature of the adhesive material is also well known to the skilled person. In many cases, a PVA-c, Waterglass, Starch based glues or hotmelt glue will be used.

After the adhesive material is applied on top of the lower band of material 11, the upper band 11′ is placed on top of the lower band 11′, and pressure may be applied, for instance using rollers. Next, adhesive material is applied on top of the upper band 11′. The adhesive material is applied within regions 13, again regularly spaced. These areas, however, are offset with respect to the areas 14 with half the spacing of the previous regions 14, as indicated. They also have the same pitch. In this way, the honeycomb with the hexagon shaped cells can be produced.

At the ends of the bands 11, 11′ a strip 12 is cut from the bands 11, 11′. In an embodiment, the bands are not fully cut, but partly thorn. This results in free ends of fibres extending from the edges of the strips. As indicated in the drawing, after cutting the bands are advanced further and the stack of honeycomb material 3 (in an unexpanded state) are lowered. The band is applied onto the already formed stack and again a strips is cut. This procedure is repeated. Thus, almost endless, non-expanded honeycomb material is formed.

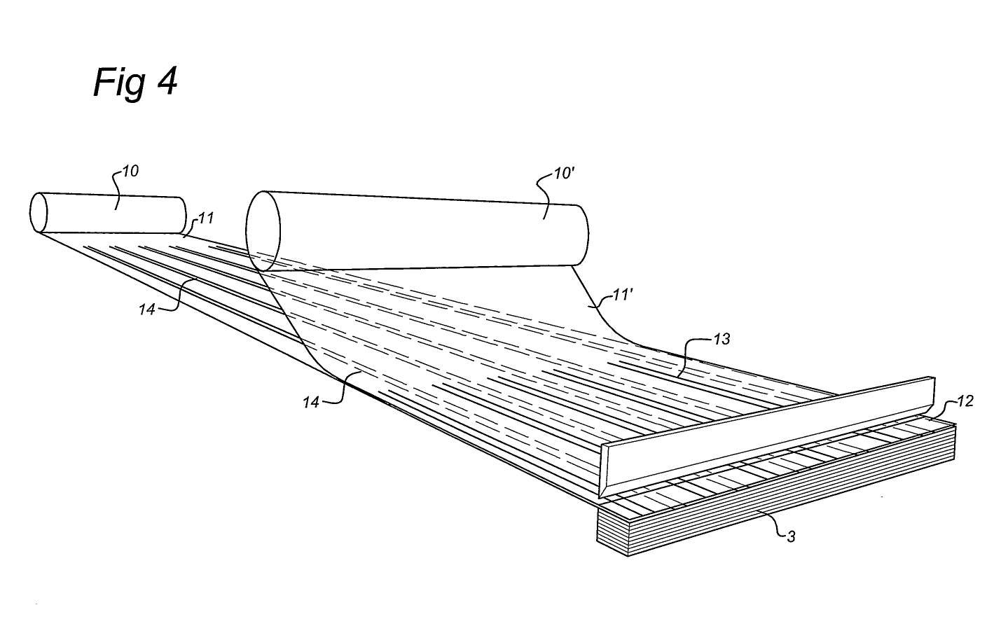

In FIG. 5, the expanding of honeycomb material after it was produced from strips of material, shown in FIG. 4, is demonstrated. Methods for expanding the honeycomb material are known to the skilled person. In this drawing, the parts resulting from the method described in FIG. 4 have the numbers used in FIG. 4.

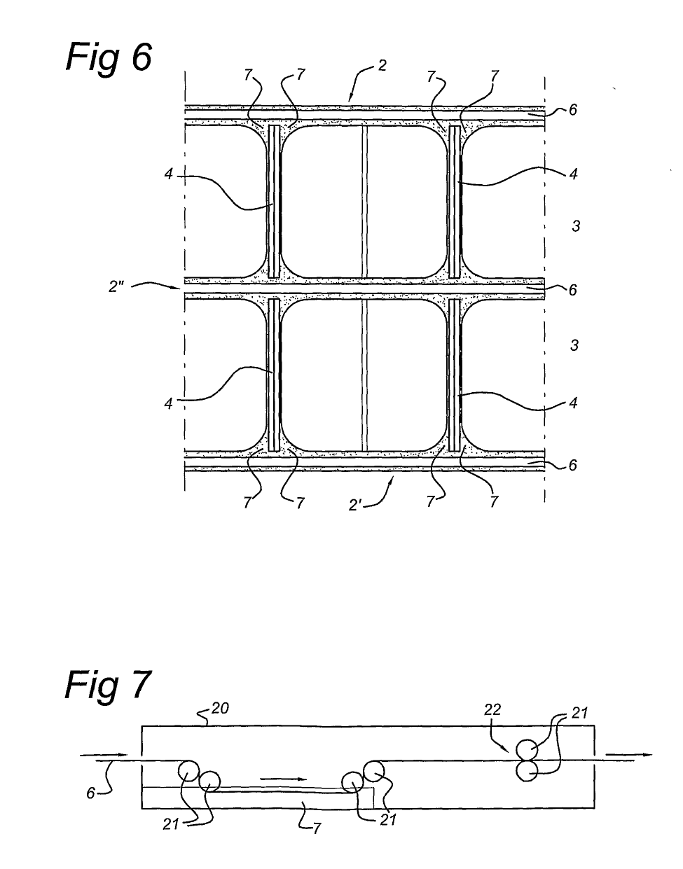

In FIG. 6, a composite panel is shown which has two layers of honeycomb material embedded in three cladding sheets. Using more layers of honeycomb material embedded between cladding sheets makes it possible to produce thicker, stronger panels of several centimetres up to 10 cm and more. These composite panels will be cheap to produce, and very ridged.

FIG. 7 shows the impregnation of fibre web 6 with a curable composition. The web 6 is here guides through a bath of curable composition 7 in a closed space 20. Entrapped air is removed by guiding the impregnated web through rollers 21. Finally, the remaining air is removed by applying ultrasound at station 22. In this way, inclusion of entrapped air in the impregnated web which seriously weakens the cladding sheets is prevented. Another method which can be used for removing entrapped air, and which can also be used as a pre-step before application of the ultrasound station is directing the impregnated webs through pressure rollers. Alternatively or in combination with these methods, the impregnated web can be directed over a vibration belt or band which vibrates the impregnated web, carried by said station. In an embodiment with vibrations in the plane of the impregnated web. Another alternative step, which again may be combined with the previous steps, is providing a station with vibrating needles which are inserted in the impregnated web and which transducer micro-vibrations in order to reduce the viscosity of the curable composition (which has, as already mentioned, the rheology modifying agent) and to allow the entrapped air to escape.

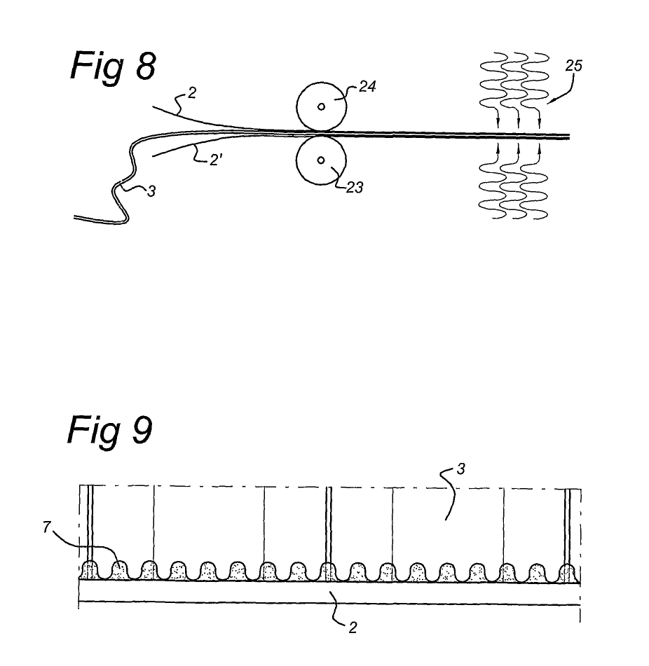

In FIG. 8, the final production steps of producing a composite panel is shown. The impregnated honeycomb material 3 and upper and lower cladding sheets 2, 2′ are joined between rollers 23 and 24. Next, the curable composition which impregnates both the honeycomb core 3 and the cladding sheets 2, 2′ is cured at curing station 25. Thus, it is demonstrated that the composite panel is here produced in a continuous process in which the honeycomb core and webs for cladding sheets are impregnated with a curable composition, joined together and cured.

In FIG. 9, a particular embodiment of the method for producing a composite panel is shown, which uses the effect of the thixotrophy modifying agent. In rest, the curable composition becomes very viscous, and when in motion, it becomes thin liquid. In the embodiment of FIG. 9, the surface for the cladding sheet 2 which is directed towards the honeycomb material 3 has a curable composition 7 at its surface which is undulated. In this embodiment, the undulations are periodic and match the honeycomb in that the sides of the strips are embedded in a relatively thick layer of curable composition 7. Together with the free fiber ends or butted edges of the strips this provides a large area for attaching the honeycomb material 3 to the cladding sheets 2.

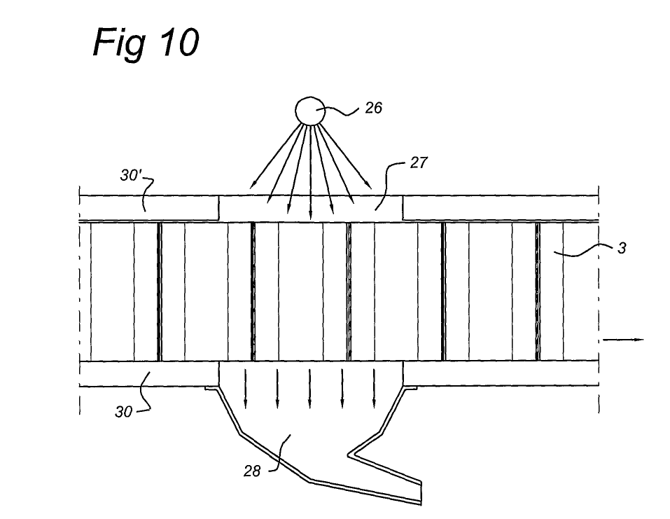

In FIG. 10, a embodiment of a station for impregnating the honeycomb material is shown. In the general process shown in FIG. 8, this will be placed before the cladding sheets are added to the panel, i.e. before rollers 23 and 24.

This station is engineered in such a way that almost no solvent is released to the air during manufacturing. Also in the rest of the process as indicated in the previous drawings, most of the steps are done in a closed environment in order to prevent pollution.

The impregnation station of FIG. 10 has a tunnel with an upper and lower wall 30, 30′. The honeycomb material 3 runs between these walls 30, 30′ in the direction indicated with the arrow at the right. Along the width of the honeycomb material 3 a slit or opening 27 is provided in the upper wall 30′ and a source of curable composition 26 is provided which sprays (or just drips or pours) curable composition on the honeycomb material 3. This source 26 can also be provided in a closed compartment, opening only into the opening 27 in wall 30′. Below the source 26 an outlet 28 is provided which can be kept at an underpressure for removing non-used material. This outlet 28 is also provided over the width of the honeycomb material 3. As this station can be sealed off from the environment, it is very well suited for using isocyanate-functional components which need to be cured by moisture, for instance, under controlled conditions. Furthermore, release of curable composition to the environment can be minimized.

The composite panels of the invention produced using the method of the invention can be produced in very large areas while having homogeneous material properties. As the honeycomb core is continuous, there are no regions or parts which have a larger stiffness, which may result in cracks or delamination when a load is placed onto it. As mentioned above, it may be produced in widths of up to 2.5 meters or more, and in any desired length. It can be very light, and cheap to produce. Furthermore, it can resist harsh climate conditions, moisture and pests, insects and moulds and funguses. It may thus be used for flooring for containers, for instance, or for aircraft flooring, for instance.

It will also be evident that the above description and drawings are included to illustrate some embodiments of the invention, and not to limit its scope of protection. Starting from this disclosure, many more embodiments will be evident to a skilled person which are within the scope of protection and the essence of this invention and which are obvious combinations of prior art techniques and the disclosure of this patent.

1-21. (canceled)

22. A method for producing a composite panel comprising a paper honeycomb core and a panel attached to both sides of the honeycomb core in a continuous process, said method comprising the steps of:
producing a continuous paper honeycomb from at least one band of paper by cutting strips of paper in substantially transverse direction off of the band of paper, stacking said strips onto one another while being attached at various locations along the length of the strips to form the continuous honeycomb in compressed form;
expanding said compressed continuous paper honeycomb and impregnating it with a curable composition;
impregnating a first and second continuous fibre-reinforced web with said curable composition, or a further curable composition which chemically binds to said curable composition;
removing entrapped air from said impregnated fibre-reinforced web;
applying said first and second impregnated fibre-reinforced web against respective both sides of said impregnated paper honeycomb core to form a continuous composite panel;
feeding said continuous composite panel through a curing station for continuously curing said curable composition; and then
cutting a composite panel from said continuous composite panel.

23. The method according to claim 22, wherein said step of producing the continuous paper honeycomb comprises:
providing sets of two rolls of paper material, and unrolling set of two rolls into a first and second band of paper material;
applying adhesive material along lines on one side of said first bands of paper material of said sets; and then
applying adhesive material along lines on one side of said second bands of paper material of said sets, said lines halve a pitch offset with respect to said lines on said first bands of paper material.

24. The method according to claim 22, wherein said curable composition is a curable resin composition.

25. The method according to claim 22, wherein said curable composition is a curable resin composition which comprises a resin selected from the group consisting of polyester, polyurethane, epoxy, and combinations thereof.

26. The method according to claim 22, wherein said honeycomb core material is impregnated with a curable composition comprising compounds selected from the group consisting of caprolactam, acrylate monomers, and isocyanate functional molecules.

27. The method according to claim 22, wherein said step of removing entrapped air comprises subjecting said impregnated fibre reinforced web to ultrasound of micro vibrations before application against respective both sides of said impregnated paper honeycomb core.

28. The method according to claim 22, further comprising:
processing sides of said strips of paper of said honeycomb for at least one of providing free fibre ends extending from said sides and for increasing the adhesive surface of said honeycomb with said panels.

29. A composite panel comprising:
a paper honeycomb core, and
cladding sheets attached to both sides of the honeycomb core, said cladding sheets comprising a fibre reinforced web impregnated with a curable composition to attach said cladding sheets to said honeycomb core,
wherein said paper honeycomb core is impregnated with said curable composition before being attached to said cladding sheets, has cells with an inscribed circle diameter of 4-25 mm, and is composed of continuous paper strips which are lengthwise oriented in the transverse direction of the composite panel, said paper honeycomb core being produced from a continuous paper honeycomb from at least one band of paper by cutting strips of paper in a substantially transverse direction off of the at least one band of paper, stacking said strips onto one another while being attached at various locations along the length of the strips to form a continuous honeycomb in compressed form, and expanding said compressed continuous paper honeycomb and impregnating it with said curable composition.

30. The composite panel of claim 29, wherein said cells have an inscribed circle diameter of 5-10 mm.

31. The composite panel of claim 29, wherein said honeycomb core has a height of 4-20 mm.

32. The composite panel of claim 29, wherein said panel has a width of about 1.2-2.5 m and the honeycomb core is a continuous honeycomb core, and said paper strips have a length of at least 2000 mm.

33. The composite panel of claim 29, wherein said paper strips have a length of at least 2600 mm, in an embodiment al least 2800 mm.

34. The composite panel of claim 29, wherein said honeycomb core comprises at least two stacked honeycomb layers, with a cladding sheet between each honeycomb layer.

35. A floor panel for a shipment container, the floor panel comprising:
a composite panel comprising a paper honeycomb core, and cladding sheets attached to both sides of the honeycomb core, said cladding sheets comprising a fibre reinforced web impregnated with a curable composition to attach said cladding sheets to said honeycomb core,
wherein said paper honeycomb core is impregnated with said curable composition before being attached to said cladding sheets, has cells with an inscribed circle diameter of 4-25 mm, and is composed of continuous paper strips which are lengthwise oriented in the transverse direction of the composite panel, said paper honeycomb core being produced from a continuous paper honeycomb from at least one band of paper by cutting strips of paper in a substantially transverse direction off of the at least one band of paper, stacking said strips onto one another while being attached at various locations along the length of the strips to form a continuous honeycomb in compressed form, and expanding said compressed continuous paper honeycomb and impregnating it with said curable composition.

36. The floor panel of claim 35, comprising one of said composite panel extending over its width and length.
